(19) United States
(12) Patent Application Publication
(10) Pub. No.: US 2017/0351999 A1
(43) Pub. Date: Dec. 7, 2017

(54) TEMPERATURE CONTROL SYSTEMS USING TEMPERATURE SUSTAINING BAGS AND METHODS OF CONTROLLING PRODUCT TEMPERATURES DURING DELIVERY

(71) Applicant: Wal-Mart Stores, Inc., Bentonville, AR (US)

(72) Inventors: David C. Winkle, Bella Vista, AR (US); Donald R. High, Noel, MO (US)

(21) Appl. No.: 15/611,487

(22) Filed: Jun. 1, 2017

Related U.S. Application Data
(60) Provisional application No. 62/345,443, filed on Jun. 3, 2016.

(51) Int. Cl. G06Q 10/08; B65D 81/38; F28D 20/00

(52) U.S. Cl. CPC G06Q 10/0832; F28D 20/0034; B65D 81/3895; F28D 2020/0069; F28D 2020/0026

(57) ABSTRACT

In some embodiments, systems and methods are provided that limit the change in temperature and/or control a temperature of a product during delivery comprising: a plurality of temperature sustaining bags comprises: a product cavity; an interior casing; an exterior casing; and an encapsulation cell encapsulating a temperature sustaining agent; memory; and a product delivery control circuit configured to: obtain dimensions of the first product and a first transport temperature threshold; obtain transport parameters comprising a predicted transport duration and expected environmental conditions; select, based on the dimensions of the first product, the transport parameters and first transport temperature threshold, a first temperature sustaining bag with a first temperature sustaining agent having a loading temperature that is less than or equal to the first transport temperature threshold; and cause a first instruction to be communicated to cause a worker to load the first product into the first temperature sustaining bag.

### CROSS-REFERENCE TO RELATED APPLICATION

This application claims the benefit of U.S. Provisional Application No. 62/345,443, filed Jun. 3, 2016, which is incorporated herein by reference in its entirety.

### TECHNICAL FIELD

This invention relates generally to product temperature control systems.

### BACKGROUND

In a modern retail environment, there is a need to improve the customer service and/or convenience for the customer. One aspect of customer service is the delivery of products. There are numerous ways to delivery products to customers. Getting the product to a delivery location, however, can adversely affect the product, can cause undesirable delays, can add cost and reduce revenue.

### BRIEF DESCRIPTION OF THE DRAWINGS

Disclosed herein are embodiments of systems, apparatuses and methods pertaining to product temperature control systems. This description includes drawings, wherein:

FIG. 1 illustrates a simplified block diagram of an exemplary product delivery coordinating system configured to coordinate and/or schedule delivery of products while limiting temperature changes and/or maintaining temperatures of one or more products while transported to one or more delivery locations, in accordance with some embodiments.

FIG. 2 illustrates an exemplary system for use in implementing methods, techniques, devices, apparatuses, systems, servers, sources and the like in limiting temperature changes of a product during transit, in accordance with some embodiments.

FIG. 3 illustrates a simplified cross-sectional view of an exemplary temperature sustaining bag, in accordance with some embodiments.

FIG. 4 illustrates a simplified block diagram of a temperature sustaining bag that further includes one or more fluid distributing and/or absorbent materials within an encapsulation cell, in accordance with some embodiments.

FIG. 5 illustrates a simplified flow diagram of an exemplary process of limiting temperature changes of a product during transit, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful to limit changes in temperature of one or more products being transported to a delivery location. By limiting changes of temperature, products can be kept below or above threshold temperatures, maintain a freshness of products, and other such benefits. In some embodiments, the system identifies various delivery parameters in selecting a product cooling system, from multiple different available cooling systems, that is to be used in limiting temperature changes and/or maintaining temperatures of one or more products while the one or more products are transported to one or more delivery locations. The cooling systems can be implemented to provide temperature control of one or more products, typically a limited number of products, and without having to control the temperature of an entire delivery vehicle or large compartment of a delivery vehicle. Accordingly, the multiple product cooling systems can limit temperature variations and/or control temperatures specific to individual or limited numbers of products. Further, in some embodiments the cooling systems are configured to have a relatively small volume. In some implementations, the product temperature control systems (e.g., product cooling systems) can provide individual temperature control for a single product. Such individual temperature control allows individual products to be transported by some delivery methods while still maintaining desired temperature thresholds, and/or can transport one or more products that are to be maintained at different desired temperatures along with other products that do not require temperature control by the same delivery vehicle.

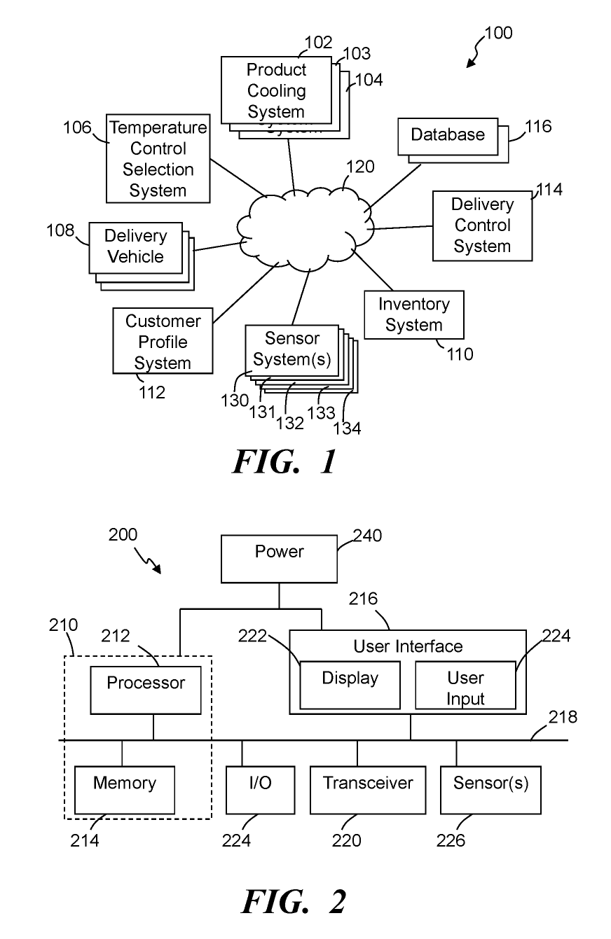

FIG. 1 illustrates a simplified block diagram of an exemplary product delivery coordinating system 100 that is configured to coordinate and/or schedule delivery of products while limiting temperature changes and/or maintaining temperatures of one or more products while transported to one or more delivery locations, in accordance with some embodiments. The system 100 includes multiple different types of product temperature sustaining, cooling and/or heating systems 102-104, a temperature control selection system 106, and multiple different types of delivery vehicles 108. Some embodiments further include one or more inventory systems 110 associated with one or more retail facilities, customer profile system 112, delivery control system 114, and one or more databases 116 (e.g., one or more customer databases, inventory databases, product databases, route parameter databases, etc.). One or more computer and/or communication networks 120 establish communication connections between two or more of the components of the system 100 and allow communications and/or data transmissions between two or more of the components of the system 100. In some embodiments, the delivery coordinating system 100 is associated with one or more retail facilities from which products can be purchased and/or that coordinates delivery of those products. The shopping facility may, in some instances, be a retail sales facility, a fulfillment center, a distribution center, or other type of facility in which products are sold and/or distributed to customers. The facility may be any size or format, and may include products from one or more merchants. For example, a facility may be a single store operated by one merchant, a chain of two or more stores operated by one entity, or may be a collection of stores covering multiple merchants.

The temperature control selection system 106 utilizes product parameters and delivery parameters in evaluating which product temperature sustaining system and/or delivery vehicle are to be employed in transporting one or more products to one or more delivery locations. Typically, the temperature control selection system identifies products that have one or more temperature thresholds that are to be maintained and/or not to be exceeded. For example, a product may have one or more of a desired storage threshold temperature, a desired transport temperature threshold, a regulatory or government specified temperature threshold, other such temperature thresholds, and in some instances a combination of two or more temperature thresholds. Further, some of the temperature thresholds may correspond to time thresholds, where for a particular product it may be desired that the product be maintained below a first temperature threshold, but can exceed the first temperature for less than a threshold duration of time and typically while being maintained under a second temperature threshold. One or more databases may be accessed (e.g., product database, inventory database, regulatory database, etc.) to obtain information about one or more temperature thresholds and/or corresponding duration thresholds. The databases may be locally maintained and/or remotely accessed over a distributed network.

Some embodiments include one or more sensor systems that communicatively couple with the temperature control selection system 106, the delivery control system 114, delivery vehicles 108, inventory system 110, other systems, two or more of such systems. The sensor systems can include one or more optical, infrared and/or other such distance and/or dimensions sensor systems 130 that provide dimensions information of one or more products to be delivered; one or more product identifying sensors 131 (e.g., RFID tag readers, bar code scanner, image recognition systems, text capture systems, etc.); one or more temperature sensor systems 132 (e.g., infrared temperature sensor, optical pyrometer sensor, fiber optic temperature sensor, etc.) configured to detect temperatures and/or temperature variations of products and/or product temperature sustaining systems 102-104; one or more weight sensors 133 to provide weight data of products, product temperature sustaining systems 102-104, one or more products cooperated with a measure and/or product temperatures sustaining system; movement sensor systems 134 to detect movement of products; other such sensor systems, or combination of two or more of such sensor systems. In some applications, the one or more sensor systems 130-134 may be positioned adjacent a conveyor system that transports products intended to be delivered. Similarly, one or more sensor systems may be positioned in packaging areas were products are prepared for delivery, adjacent routes along which products are transported, adjacent doors of temperature control areas, and/or other such locations within the facility, as part of a transport system (e.g., forklift, pallet jack, etc.), and/or other such systems. The sensor systems can provide relevant information to the delivery control system 114, temperature control selection system 106, the inventory system 110, the delivery control system 114 and/or other such systems.

Some embodiments further utilize the sensor data to confirm product information and/or characteristics maintained in one or more databases 116. For example, sensor data can confirm temperature, dimensions and/or weight of products, expected combined dimensions, expected combined weight, and other such information. Again, the sensor and/or database information are applied in selecting the temperature sustaining bag system to be used during delivery. The sensor data and database data may further be used in determining an optimal orientation of multiple products. For example, products with a slower rate of temperature change can be oriented around products with faster rates of temperature change, while confirming that such an orientation does not exceed a desired total dimension.

Further, the temperature control selection system typically takes into consideration transportation parameters in selecting a product temperature sustaining system 102-104 to be used in transporting one or more products. The transport parameters can include, but are not limited to, expected duration of transport and/or duration of exposure to non-temperature controlled environments (e.g., outside of a freezer or refrigerator), predicted and/or forecasted environmental conditions through which the product(s) is to be transported (e.g., temperatures, humidity, potential wind, precipitation, etc.), and other such information. The transportation parameters may be obtained based on historic data (e.g., historic weather, historic traffic patterns, data obtained from similar previous deliveries, etc.) and forecasted data (e.g., forecasted weather, forecasted traffic, etc.), current data, and the like. Further, the transportation parameters may be obtained based on information collected by the retail store or chain of stores, and/or one or more third party sources (e.g., one or more weather services, traffic service, delivery service, etc.). Typically, the transportation parameters can further include and/or consider the time, temperature and the like associated with the preparation and/or loading of the product into a temperature sustaining system and/or the delivery vehicle, the unloading of the delivery vehicle, and other such factors. The system may take other parameters into consideration including, but not limited to, product parameters (e.g., type of product, size of product, size of multiple products (e.g., sum of volumes and/or volume of strategically arranged products), and the like), customer requests, types of delivery location, whether a temperature control system is available at the delivery location, whether a customer is expected to be available to receive the product(s) at the time of delivery, and other such parameters, and often a combination of two or more of such parameters.

Further, the processes, methods, techniques, circuits, circuitry, systems, devices, functionality, services, servers, sources and the like described herein may be utilized, implemented and/or run on many different types of devices and/or systems. FIG. 2 illustrates an exemplary system 200 that may be used for implementing any of the components, circuits, circuitry, systems, functionality, apparatuses, process, or device of the system 100 of FIG. 1 and/or mentioned above or below, or parts of such circuit, circuitry, functionality, systems, apparatuses, processes, or devices. For example, the system 200 may be used to implement some or all of the product temperature sustaining systems 102-104, a temperature control selection system 106, delivery vehicles 108, inventory systems 110, customer profile system 112, delivery control system 114, and/or other such components, circuitry, functionality and/or devices. However, the use of the system 200 or any portion thereof is certainly not required.

By way of example, the system 200 may comprise a control circuit or processor module 212, memory 214, and one or more communication links, paths, buses or the like 218. Some embodiments may include one or more user interfaces 216, and/or one or more internal and/or external power sources or supplies 240. The control circuit 212 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 212 can be part of control circuitry and/or a control system 210, which may be implemented through one or more processors with access to one or more memory 214 that can store code that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 200 may be used to implement one or more of the above or below, or parts of, components, circuits, systems, process and the like. For example, the system may implement the temperature control selection system 106 with the control circuit being a selection system control circuit, product cooling system with the control circuit being a cooling system control circuit, a product delivery control system with the control circuit being a product delivery control circuit, a temperature control system with a temperature control circuit, or other components.

The user interface 216 can allow a user to interact with the system 200 and receive information through the system. In some instances, the user interface 216 includes a display 222 and/or one or more user inputs 224, such as a buttons, touch screen, track ball, keyboard, mouse, etc., which can be part of or wired or wirelessly coupled with the system 200. Typically, the system 200 further includes one or more communication interfaces, ports, transceivers 220 and the like allowing the system 200 to communicate over a communication bus, a distributed computer and/or communication network 120 (e.g., a local area network (LAN), the Internet, wide area network (WAN), etc.), communication link 218, other networks or communication channels with other devices and/or other such communications or combinations thereof. Further the transceiver 220 can be configured for wired, wireless, optical, fiber optical cable, satellite, or other such communication configurations or combinations of two or more of such communications. Some embodiments include one or more input/output (I/O) ports 234 that allow one or more devices to couple with the system 200. The I/O ports can be substantially any relevant port or combinations of ports, such as but not limited to USB, Ethernet, or other such ports.

The system 200 comprises an example of a control and/or processor-based system with the control circuit 212. Again, the control circuit 212 can be implemented through one or more processors, controllers, central processing units, logic, software and the like. Further, in some implementations the control circuit 212 may provide multiprocessor functionality.

The memory 214, which can be accessed by the control circuit 212, typically includes one or more processor readable and/or computer readable media accessed by at least the control circuit 212, and can include volatile and/or nonvolatile media, such as RAM, ROM, EEPROM, flash memory and/or other memory technology. Further, the memory 214 is shown as internal to the control system 210; however, the memory 214 can be internal, external or a combination of internal and external memory. Similarly, some or all of the memory 214 can be internal, external or a combination of internal and external memory of the control circuit 212. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory. The memory 214 can store code, software, executables, scripts, data, content, lists, programming, programs, log or history data, user information and the like. While FIG. 2 illustrates the various components being coupled together via a bus, it is understood that the various components may actually be coupled to the control circuit and/or one or more other components directly.

Some embodiments include the I/O interface 234 that allows wired and/or wireless communication coupling of to external components, such as with one or more product temperature sustaining systems 102-104, temperature control selection system 106, delivery vehicles 108, inventory systems 110, customer profile system 112, delivery control system 114, databases 116, and other such devices or systems. Typically, the I/O interface provides wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some implementations, the system 200 includes one or more sensors 226 that can communicate sensor data to the control circuit 212 and/or other systems. The sensors can include one or more temperature sensors, humidity sensors, inertial sensors, wind speed sensors, acceleration sensors, velocity sensors, other such sensors, or combination of two or more of such sensors. The sensors may communicate wired or wirelessly over the communication link 218, the distributed computer and/or communication network 120, or the like. Further, the sensors 226 are illustrated directly coupled with the control circuit 212 via the communication link 218; however, one or more sensors may be internal, external or a combination of internal and external, other networks or communication channels with other devices and/or other such communications or combinations thereof. For example, in some applications one or more temperature sensors may be positioned within a product holder or cavity of a temperature sustaining system, adjacent to or as part of a product holder, incorporated into insulation, external to a housing of a cooling system, other such locations, or combination of two or more of such locations.

As described above, some embodiments include the temperature control selection system 106 that evaluates multiple parameters to select a product temperature control system from multiple different types of temperature control systems for one or more products to be delivered. The temperature control systems can comprise one or more temperature sustaining bags, evaporative temperature control systems, temperature pack cooling systems, cryogenic substance cooling systems, aerosol temperature control systems, heat pack temperature systems, other temperature control systems, or combination of two or more of such systems. Some embodiments further select between the same type of temperature sustaining systems, such as selecting between a plurality of temperature sustaining bags that have different sizes, different temperature sustaining characteristics, and the like.

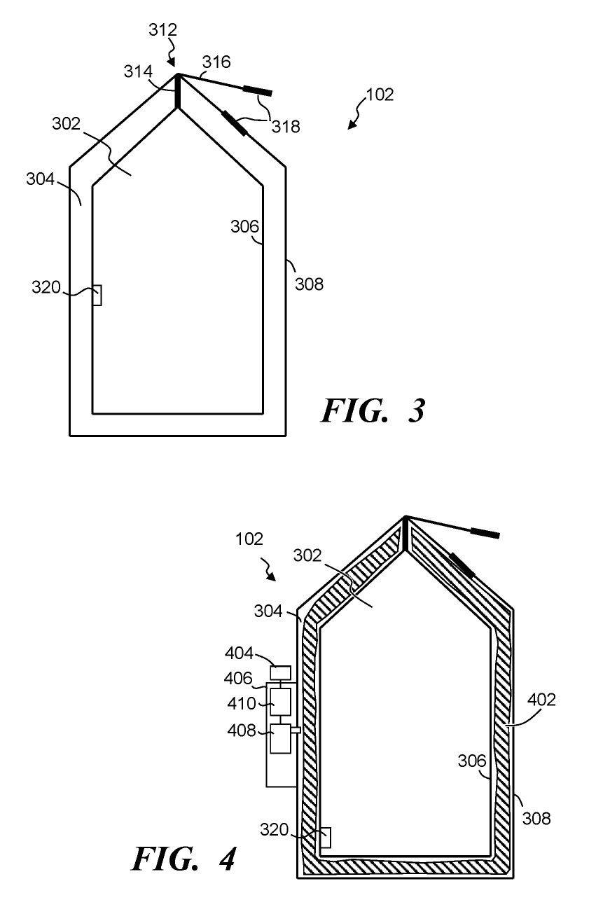

FIG. 3 illustrates a simplified cross-sectional view of an exemplary temperature sustaining bag 102, in accordance with some embodiments. The temperature sustaining bag includes one or more product cavities 302 that each support one or more products while the products are transported to a delivery location by a delivery vehicle. In some embodiments, the temperature sustaining bag includes an interior casing 306 that defines the boundary of the product cavity 302, and an exterior casing 308, which is typically separated from the interior casing by a distance, gap, spacing, or the like that comprises a cooling cavity. Further, the temperature sustaining bag includes one or more encapsulation cells 304 that are positioned and/or defined between the interior casing 306 and the exterior casing 308. In some instances, a single encapsulation cell is included, while in other implementations, multiple encapsulation cells can be positioned between the interior and exterior casings.

Each encapsulation cell 304 is configured to receive and encapsulate one or more temperature sustaining agents. In some embodiments, the one or more encapsulation cells can be formed from a bladder, tube, balloon, other such structure or combination of such structures. Further, the encapsulation cell may further be formed from a flexible material, such as but not limited to rubber, silicon, plastic, etc. In some implementations, two or more encapsulation cells may have different sustaining agents to achieve a desired temperature within the product cavity 302 and/or to provide a desired duration of rate of temperature change within the product cavity.

The interior casing is typically formed from a moisture resistant material, and in some instances from a waterproof material such as plastic, silicon, rubber, or the like. The exterior casing 308 may, in some implementations, also be formed from a moisture resistant material, and in some embodiments may include or be positioned adjacent an insulating layer or material (e.g., neoprene, wool, foam, polar fleece, rubber, other such materials or combination of two or more of such materials). For example, one or more insulations may be positioned between the encapsulation cells and the exterior casing. Further, in some embodiments, the interior and exterior casings are flexible allowing the casings (or cooperatively the shell) and the temperature sustaining bag 102 to bend, flex or otherwise partially deform. The interior and exterior casing materials may in some implementations further be selected to resist threshold levels of pressure to resist punctures, tears, and other damage, and/or include tear limiting features. In some embodiments, one or more exterior couplers, loops, straps, harnesses, other such structures or combination of such structures are cooperated at least with the exterior casing allowing the temperature sustaining bag to be carried and/or secured with a delivery vehicle, tote carried by a delivery vehicle, or the like. Typically, the temperature sustaining bag is separate from and removable from the delivery vehicle.

The size of the temperature sustaining bags 102 can vary, but often are configured to hold a relatively small number of products, such as products that collectively have a volume of less than three cubic feet, typically less than two cubic feet, and often less than one cubit foot. In many implementations, a single product is placed into a temperature sustaining bag. Further, the product delivery control system 114 can typically select between multiple different sized temperature sustaining bags based at least in part on the size of the one or more products to be transported while within the temperature sustaining bag, one or more temperature thresholds associated with a product, desired overall size of the package (e.g., one or more products and the temperature sustaining bag), thermal mass of the product, weight of the product, weight of the potential package, and the like. Depending on the size of the product, often the temperature sustaining bag is capable of only receiving a single product. In some embodiments, the temperature sustaining bag is selected to have dimensions that are only marginally larger than the one or more products being received by the temperature sustaining bag. For example, in some applications, the temperature sustaining bag adds less than 15% to a total volume of the one or more products (and their packaging) being placed within the temperature sustaining bag, while in some instances the size of the temperature sustaining bag selected adds 10% or less to a volume of the one or more products intended to be placed in the temperature sustaining bag.

Further, in some embodiments, the delivery control system 114 evaluates multiple products in determine whether to cooperate products and/or in selecting products to be cooperated into a single temperature sustaining bag. In some embodiments, for example, the delivery control system 114 identifies a mode of transport of the products, identifies a weight threshold and size threshold based on the mode of transport, receives weight data from the one or more weight sensor systems 134, and further receives dimensions from the one or more dimensions sensor systems 130. The delivery control system process the data to identify a combination of two or more products that can be combined while still being within the size and weight thresholds, and have temperature thresholds that allow that the two or more products can be combined to fit within a select size of a temperature sustaining bag that has a thermal mass and/or rate of change of temperature relative to the expected temperatures to which the temperature sustaining bag is to be exposed and is consistent with the expected delivery duration. Further, the temperature thresholds of the combined products confirms, based on product data in one or more databases, that damage will not occur to one or more products (e.g., product A having a first temperature threshold is not damaged by being in a temperature sustaining bag at a second temperature that is less than the first temperature threshold and is below a second temperature threshold of a second product that is lower than the first temperature threshold).

In some embodiments the temperature sustaining bag can include a closing mechanism 312 that allows the temperature sustaining bag to close the product cavity 302 from the exterior environment. The closing mechanism can include one or more of a zip lock seal 314, lid, one or more snaps, one or more zippers, an extended flap 316 that folds over and can be secured (e.g., one or more snaps, Velcro™ 318, zip lock, zipper, etc.), one or more flaps that can be rolled, one or more removable clips, other such closing mechanisms, or combination of two or more of such closing mechanism. In some implementations, the closing mechanism may further seal the product cavity, which can limit rain, dirt or the like from entering the product cavity. Further, some embodiments include a closing mechanism that allows the product cavity to be vacuum sealed. The vacuum seal may further allow some or substantially all of the air removed from the product cavity causing at least the interior casing, and in some instances, the temperature sustaining bag to collapse around the one or more products within the product cavity. A vacuum port may be included extending through the exterior and interior casings to enable air to be moved from the sealed product cavity. The removal of excess air or other gas can reduce the size of the resulting package, and in some instances enhance sustaining the desired temperature and/or reducing a rate of change of the temperature of the product.

The width of the encapsulation cells 304 and/or the separation between the interior casing and the exterior casing can be configured based on an expected quantity of temperature sustaining agent to be maintained within the cavity. Further, in some instances the width may vary over the dimensions of the temperature sustaining bag (e.g., wider at a bottom than at a bottom, wider proximate one or more areas are a product can be secured, or some other configuration).

Some embodiments include one or more temperature sensors 320 that can be positioned to detect in real time a temperature corresponding to a temperature of one or more products within the product cavity 302 while the one or more products are in transit to be delivered to a delivery location. In some instances, a temperature sensor may be positioned in contact with a product within the product cavity. Additionally or alternatively, one or more temperature sensors may be positioned at one or more locations within the product cavity. Some embodiments include one or more temperature sensors that can detect temperatures outside of the temperature sustaining bag. One or more other types of sensors may be included, such as but not limited to one or more humidity sensors, inertia sensors, orientation sensors (e.g., tilt, roll, pitch, yaw, etc.), airflow sensors, other such sensors, or combination of two or more of such sensors. The sensors may be in wired or wireless communication with a transmitted to provide wireless communication from the temperatures sustaining bag (e.g., to the delivery control system 114) and/or to a temperature control circuit 404 (see FIG. 4) and communicate sensor data.

Some embodiments include one or more fluid distributing and/or absorbent materials 402 within one or more of the encapsulation cells. FIG. 4 illustrates a simplified block diagram of a temperature sustaining bag 102 that further includes one or more fluid distributing and/or absorbent materials 402 within an encapsulation cell, in accordance with some embodiments. The fluid distributing material is positioned within an encapsulation cell and is configured to provide a more equal and consistent distribution of the temperature sustaining agent throughout the encapsulation cell. The fluid distributing material can be substantially any material that can at least partially absorb and/or wick the temperature sustaining agent (e.g., paper material, wool, cotton, polar fleece, sponge, material with capillary channels, etc.). In some applications the fluid distributing material is a fibrous material that provides a relatively large surface area. The fluid distributing material may further provide some insulation between the product cavity and the exterior environment.

The temperature sustaining bag is configured to receive one or more products and limit temperature changes of the products at least while being transported to a delivery location. In some embodiments a control circuit 210 of the product delivery system 114, while implementing computer instructions stored on memory 214 obtains dimensions of one or more products to be delivered and for which temperature change is to be limited. At least one of the products typically is associated with a transport temperature threshold below which the product to be maintained while transported to the delivery location by the delivery vehicle. Further, transport parameters are obtained that can have an effect on the temperature of a product, a rate of temperature change of the product, and other effects on the temperature of the product at least while being transported to the delivery location. For example, the transport parameters may include, but are not limited to a predicted duration of transport and/or duration of exposure to non-temperature controlled environments, predicted and/or forecasted environmental conditions through which the product(s) is to be transported, and other such information.

In some embodiments, the temperature sustaining bag may further include a temperature control circuit 404 that can autonomously activate a dispensing system 406. The dispensing system, in some applications, includes one or more reservoirs 408 that store one or more types of agents or chemicals that can be released into one or more encapsulation cells to cause a chemical reaction (e.g., endothermic, exothermic, etc.) to further sustain a desired temperature. In some embodiments, the dispensing system includes a control circuit and/or actuator 410, which may comprise a valve, plunger, puncture pin, or other such actuator that can inject one or more agents into one or more encapsulation cells to cause the chemical reaction to result in a reduction in temperature or increase in temperature depending on the desired temperature attempting to be sustained.

Based on the dimensions of the one or more products, the transport parameters, and temperature threshold, a temperature sustaining bag is selected that has a temperature sustaining agent having a loading temperature that is less than or equal to the first temperature threshold. The load temperature corresponds to a temperature of at least the temperature sustaining agent when the product is loaded into the temperature sustaining bag and/or when the temperature sustaining bag and product are loaded into or on the delivery vehicle. As such, the load temperature has a predefined relationship with the temperature threshold of the product. For example, when the temperature sustaining bag attempts to keep a product cool, and thus below a temperature threshold, the load temperature is typically less than or at least equal to the temperature threshold. Typically, the one or more temperature sustaining agents of a temperature sustaining bag can be brought to a temperature that is less than the temperature threshold (or greater than a temperature threshold when attempting to maintain a warm product), and often can be at least a threshold difference in temperature from the threshold temperature. The selection of the temperature sustaining bag further includes selecting a bag with a product cavity having a sufficient volume to receive the one or more products. Further, the control circuit typically causes one or more instructions to be communicated to one or more workers directing the worker(s) to load the one or more products into the selected temperature sustaining bag. In some embodiments, the control circuit causes an instruction to be communicated to a worker's wireless user interface unit (e.g., smart phone, tablet, custom retail store electronic device, or the like). Additionally or alternatively, the instruction may be displayed through a work terminal, display screen or the like that is at least periodically visible to the worker while the worker is preparing products for delivery. In some applications, a printout may be printed that includes a listing of one or more products to be prepared for delivery and when relevant one or more corresponding temperature sustaining bags to be used with one or more of those products.

In some applications, the temperature sustaining bags are brought to a desired temperature before the product is loaded. Further, in some embodiments, temperature sustaining bags are stored in one or more temperature environments where the temperature sustaining bags can be maintained at desired temperatures and used depending on the threshold temperature of products. For example, some temperature sustaining bags may be stored in a refrigerated temperature environment of the shopping facility, fulfillment facility or the like, and maintained at a refrigerated temperature (e.g., at about 38° F.), while other temperature sustaining bags are stored in first freezer and maintained at a first freezer temperature (e.g., at about 15° F.), while still other temperature sustaining bags are in a second freezer at a second freezer temperature (e.g., at about −10° F.), while still other temperature sustaining bags are maintained in a warming temperature environment and maintained at a first warming temperature (e.g., about 120° F.). The temperature sustaining bags can be pre-cooled or pre-heated to substantially any desired temperature corresponding to thresholds of products expected to and/or scheduled to be delivered. As such, in some applications a temperature sustaining agent in a temperature sustaining bag is at or below the loading temperature prior to a temperature sustaining bag being selected for a particular product.

Further, in many embodiments, the temperatures sustaining bags are ready for use and do not require assembly before a temperature sustaining bag is selected. Accordingly, with these embodiments, the temperature sustaining bags are complete, ready for use and easily utilized without assembly to receive the product at the time the first temperature sustaining bag is selected. Other embodiments cause a temperature sustaining bag to be manufactured or assembled at least in part based on the one or more products intended to be placed into the sustaining bag. The control circuit may, in selecting the temperature sustaining bag, determine interior dimensions of the product cavity 302 in order to receive the one or more intended products. In some instances, the volume of each product to be placed into the temperature sustaining bag are summed, while in other instances an arrangement of the one or more products can be determined and a volume of that arrangement determined. The control circuit can further determine a quantity of one or more temperature sustaining agents to be encapsulated in one or more encapsulation cells. This determined quantity is typically based on a predicted quantity to use in order to maintain the temperature of the one or more product below (or above) the transport temperature threshold relative to the expected delivery parameters. Based on the determined dimensions of the product cavity and the determined quantity of temperature sustaining agent, the control circuit can cause one or more instructions to be communicated to cause the manufacturing of a temperature sustaining bag with the determined interior dimensions and the encapsulated quantity of the temperature sustaining agent.

The manufacturing may be performed at the shopping facility through a manufacturing system that cooperates interior casing material and exterior casing material. In some instances, the interior and exterior casing materials are measured out by the system based on the determined dimensions and sealed at relevant locations to define the folds of the temperature sustaining bag and/or the one or more encapsulation cells between the interior and exterior casings. For example, one or more rolls of casing materials may be cooperated with the manufacturing system, and a control circuit of the manufacturing system can pull out or roll out the desired length and/or width of the material, seal the casings together where appropriate (e.g., heat sealing, epoxy, etc.) to form the desired temperature sustaining bag with the desired product cavity dimensions and desired area to receive the intended quantities of temperature sustaining agent(s). In some embodiments, one or more encapsulation cell materials are further measured by the system and positioned between the casings to form the encapsulation cells. The cells may be filled with temperature sustaining agent prior to sealing the cells, while in other instances, the cells may be sealed (e.g., heat sealed, zip locked, etc.) and the temperature sustaining material injected through the wall of the encapsulation cell (e.g., through an injection port, directly through the wall and a sealant applied after injection, etc.). For example, in some implementations the control circuit determines, based at least on the transport parameters and temperature threshold, a quantity of the temperature sustaining agent to be encapsulated, and causes one or more instructions to be communicated to cause the determined quantity of the temperature sustaining agent to be injected into one or more encapsulation cells. Additionally or alternatively, some embodiments select one or more pre-constructed encapsulation cells that are inserted between the casings prior to or after formed into the intended shape of the temperature sustaining bag with the desired dimensions.

Further, some or all of the temperatures sustaining bags may be configured to have limited use, such as one, two, five or more uses, and be disposable following the number of uses. In some embodiments, the temperature sustaining bags are further constructed from biodegradable and/or non-toxic materials. For example, the casing materials may be selected to degrade in a land fill within a threshold period of time (e.g., a degradable wax coated paper, a degradable plastic, etc.). Similarly, the temperature sustaining agent can be a non-toxic agent such that it is not harmful to pets and children if exposed to, in contact with and/or consumed to threshold quantities (e.g., water, salt water, propylene glycol, glycerol, etc.). The control circuit in selecting the temperature sustaining bag can select the temperature sustaining bag based on the temperature sustaining bag being disposable with the inner and outer casings being biodegradable, and the temperature agent being non-toxic.

In some embodiments, the control circuit further causes one or more instructions to be communicated directing that the temperature sustaining bag be placed into a temperature environment at least a threshold duration prior to the product being loaded into the delivery vehicle. The threshold duration is determined based at least in part on the quantity of the temperature sustaining agent(s) such that the temperature sustaining agent is brought to at least the loading temperature prior to being placed into the delivery vehicle. The one or more products may be placed into the preconditions temperature sustaining bag after brought to the desired temperature, or placed into the temperature sustaining bag while the temperature sustaining bag is brought to desired temperature.

As described above, some embodiments select, from multiple different types of temperature systems, the temperature sustaining bag as a method of maintaining a desired temperature of one or more products. Further, the selection of the temperature sustaining bag may be based in part on the method of transport. Often, the temperature sustaining bags can be constructed of relatively light weight materials. Further, because of the different sizes, the temperature sustaining bag can be selected such that the size of the product(s) and bag are only marginally larger than the product(s) being delivered. As such, the temperature sustaining bag may be an advantageous method of limiting temperature change of products for some methods of delivery, and the temperature control selection system 106 may consider a type or method of transport and delivery when selecting a type of method to limit temperature change. For example, the method of transport may be through one or more methods such as, but not limited to, a delivery truck, a delivery van, a delivery car, an unmanned ground or land-based vehicle (UGV), an unmanned aircraft system (UAS), other such delivery methods, or combination of such delivery methods. The use of temperature sustaining bags can be used with substantially any method of delivery, and may be more advantageous with some types of delivery methods. For instances, because of the potential limited weight and size, the temperature sustaining bag may be beneficially used with UASs and UGVs. As such, in some embodiments the temperature control selection system 106 obtains the temperature threshold of one or more products to be transported, identifies a method of transporting the one or more products by one or more delivery vehicles to the delivery location, and selects from multiple different types of temperature control systems the temperature sustaining bags as a function of the method of transporting.

Some temperature control systems may not be suitable for some of the delivery methods, some temperature control systems may be more effective with some methods of delivery, and/or some temperature control systems may be more readily implemented with some delivery methods. Accordingly, the temperature control selection system may identify a scheduled method of delivering one or more products, and select the temperature sustaining bag as a method of temperature control based in part on the method of delivery. Further, the weight of temperature control systems used particularly with UASs, and in some instances with UGVs, can make some cooling systems difficult to use. In many instances, the temperature sustaining bags 102 can be implemented to have a relatively light weight (e.g., interior and exterior casings can be formed from light weight plastic, rubber, silicon, cotton, wool, paper, cardboard, Styrofoam, other such materials or combination of two or more of such materials). Accordingly, the temperature sustaining bag systems can be a desired method of limiting temperature change with some delivery methods. Delivery parameters corresponding to the method of delivery can be considered by the temperature control selection system, which can select the temperature sustaining bags for some methods of transport and delivery. Further, in some implementations, the temperature control selection system may select two or more of the temperature control systems to be cooperatively utilized during the delivery, and/or one to be used as a primary cooling system with one or more to be utilized as secondary cooling method and/or backup cooling method. Further, multiple methods of delivery may be used (e.g., delivery truck and a UAS). Accordingly, multiple temperature control systems may be selected. The temperature control selection system, in some applications, is configured to obtain a temperature threshold of a product, identify a method of transporting the product by the delivery vehicle to the delivery location, and select from multiple different types of temperature control systems an evaporative temperature control system as a secondary system to limit that comprises the product cooling system as a function of the method of transport. Other cooling systems are described in U.S. Application Nos. 62/338,231 filed May 18, 2016 entitled CRYOGENIC COOLING SYSTEMS AND METHODS OF CONTROLLING PRODUCT TEMPERATURES DURING DELIVERY (137873); 62/338,224 filed May 18, 2016 entitled EVAPORATIVE COOLING SYSTEMS AND METHODS OF CONTROLLING PRODUCT TEMPERATURES DURING DELIVERY (137875); 62/338,290 filed May 18, 2016 entitled SYSTEMS AND METHODS OF CONTROLLING PRODUCT TEMPERATURES DURING DELIVERY (137876); 62/345,443 filed Jun. 3, 2016 entitled TEMPERATURE CONTROL SYSTEMS USING TEMPERATURE SUSTAINING BAGS AND METHODS OF CONTROLLING PRODUCT TEMPERATURES DURING DELIVERY (138251); 62/403,909 filed Oct. 4, 2016 entitled SYSTEMS AND METHODS UTILIZING NANOTECHNOLOGY INSULATION MATERIALS IN LIMITING TEMPERATURE CHANGES DURING PRODUCT DELIVERY (137874); 62/350,515 filed Jun. 16, 2016 entitled SYSTEMS AND METHODS OF CONTROLLING PRODUCT TEMPERATURES DURING DELIVERY (138259); 62/367,376 filed Jul. 27, 2016 entitled SYSTEMS AND METHODS FOR DELIVERING PERISHABLE ITEMS (138262); Ser. No. 15/598,699 filed May 18, 2017 entitled EVAPORATIVE COOLING SYSTEMS AND METHODS OF COOLING PRODUCT TEMPERATURES DURING DELIVERY, and Ser. No. 15/598,718 filed May 18, 2017 entitled SYSTEMS AND METHODS OF CONTROLLING PRODUCT TEMPERATURES DURING DELIVERY, all of which are incorporated herein by reference in their entirety.

The weight data may be received from one or more weight sensing systems may be included in the system 100 and coupled with the temperature control selection system and/or the product cooling system. Similarly, one or more dimensions and/or distance measurement systems may be included in the system 100 and coupled with the temperature control selection system and/or the product cooling system, and providing size data to be used in selecting the temperature sustaining bag system (e.g., size is greater than a threshold of one or more other temperature control systems and/or delivery methods, weight is greater than a threshold of one or more other temperature control systems and/or delivery methods, etc.), and/or in selecting the temperature sustaining agent.

Further, the temperature control selection system 106 further evaluates one or more temperature thresholds relative to thermal mass of one or more products, expected rates of temperature change of one or more products as a function of the different available temperature sustaining bag systems and temperature sustaining agent(s) of those bag systems, the temperature of the products, the thermal coefficients associated with the excess space within a temperature sustaining bag, and whether the threshold temperature can be maintained based on a rate of temperature change of one or more products relative to the expected exposed temperature during the expected duration of delivery. Further, one or more databases on temperature sustaining agents and insulation characteristics (e.g., material's resistance to conductive heat flow measured or rated in terms of its thermal resistance or R-value) of one or more insulation materials of temperature sustaining bag systems are typically also evaluated. In some embodiments, the insulating rating of multiple products, the temperature sustaining agent and/or insulation between a product and an exterior temperature environment in a given direction may be summed to determine an estimated total insulation rating in that given direction, which corresponds to an estimated rate in change of temperature relative to the expected environmental conditions during delivery. Using the temperature of the one or more products, and the temperature of the sustaining agent, in addition to the rates of change of temperature of the one or more products and the sustaining agent, the system can estimate whether a desired rate of change of temperature can be achieved, based on expected environmental conditions and duration of delivery. In some embodiments, the rate of change of temperature is calculated based on a formula for each flow (e.g., ΔQ/Δt=−K×A×ΔT/x, where ΔQ/Δt is the rate of heat flow; −K is the thermal conductivity factor; A is the surface area; ΔT is the change in temperature and x is the thickness of the material).

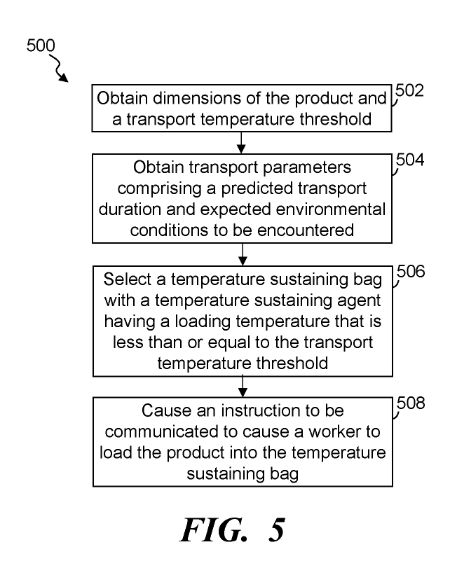

FIG. 5 illustrates a simplified flow diagram of an exemplary process 500 of limiting temperature changes of a product during transit, in accordance with some embodiments. In step 502, dimensions of one or more products are obtained, and a transport temperature threshold is obtained for at least one of the products. Again, the transport temperature threshold specifies a temperature below which the at least one product is to be maintained while transported to a delivery location by a delivery vehicle.

In step 504, transport parameters are obtained corresponding to the delivery. In some embodiments, the transport parameters comprises a predicted transport duration and expected environmental conditions to be encountered during the transport of the one or more products to the delivery location. In step 506, a first temperature sustaining bag is selected based on the dimensions of the first product, the transport parameters and transport temperature threshold from a plurality of different sized temperature sustaining bags. Each of the plurality of temperature sustaining bag includes one or more temperature sustaining agents that are encapsulated within one or more encapsulation cells defined between an interior casing 306 and an exterior casing 308. Further, at least one temperature sustaining agent of the selected temperature sustaining bag has a loading temperature that is less than or equal to the transport temperature threshold. In some embodiments, the selected temperature sustaining bag further includes a fluid distributing material within an encapsulation cell that is configured to distribute the temperature sustaining agent throughout the encapsulation cell. In step 508, the control circuit causes one or more instruction are to be communicated to cause a worker to load the one or more product into the selected temperature sustaining bag.

In selecting the temperature sustaining bag, the control circuit in some instances selects a temperature sustaining bag that has the temperature sustaining agent at or below a loading temperature prior to the temperature sustaining bag being selected. Again, temperature sustaining bags can be placed in one or more temperature environments that can bring the temperature sustaining agent to a desired temperature. Further, the temperature sustaining bags can be stored in temperature environments so that they are ready and at a desired temperature prior to being selected, prior to a product being placed into the temperature sustaining bag, and/or prior to the product and temperature sustaining bag being cooperated with a delivery vehicle. In some embodiments, at least some temperature sustaining bags are complete and ready without assembly to receive the one or more products at the time the temperature sustaining bag is selected.

In other embodiments, the control circuit in selecting the temperature sustaining bag determines interior dimensions of the product cavity 302 to receive the one or more products, and determines a quantity of one or more temperature sustaining agents to be encapsulated and predicted to maintain the temperature of the one or more products below (or above) one or more transport temperature thresholds. The control circuit can cause one or more instructions to be communicated to cause the manufacturing of a temperature sustaining bag with the determined interior dimensions and the encapsulated quantity of the temperature sustaining agent. In some implementations, instructions can be communicated to cause the temperature sustaining bag to be placed into a temperature environment at least a threshold duration prior to the product is loaded into the delivery vehicle such that the temperature sustaining agent is brought to at least the loading temperature prior to being placed into the delivery vehicle.

A quantity of temperature sustaining agent to be encapsulated in one or more cells can be determine based at least on the transport parameters and transport temperature threshold. For example, increased transport durations may correspond to increased quantities of temperature sustaining agent and/or a selection of a temperature sustaining agent over second temperatures sustaining agent due in part to the first temperature sustaining agent having a slower rate of temperature change. Instructions can be communicated to cause the determined quantity of the temperature sustaining agent to be injected into at least one of the encapsulation cells. Further, some embodiments obtain the temperature threshold of the first product and identify a method of transporting the product by the delivery vehicle to the delivery location. A temperature sustaining bag can be selected from multiple different types of temperature control systems to be used in limiting the temperature change of the product as a function of the method of transporting.

Some embodiments provide systems, apparatuses and a corresponding methods to limit the temperature change of products during delivery. In some embodiments, system are provided that limit temperature changes of products during transit, comprising: a plurality of temperature sustaining bags including multiple different sized temperature sustaining bags, wherein each of the plurality of temperature sustaining bags comprises: a product cavity that supports a first product while the first product is transported to a delivery location by a delivery vehicle with the temperature sustaining bag being separate from and removable from the delivery vehicle; an interior casing defining the product cavity; an exterior casing; and an encapsulation cell defined between the interior casing and the exterior casing and a temperature sustaining agent encapsulated within the encapsulation cell; a product delivery control circuit; and a memory coupled to the product delivery control circuit and storing computer instructions that when executed by the product delivery control circuit cause the product delivery control circuit to: obtain dimensions of the first product and a first transport temperature threshold below which the first product to be maintained while transported to the delivery location by the delivery vehicle; obtain transport parameters comprising a predicted transport duration and expected environmental conditions to be encountered during the transport of the first product to the delivery location; select, based on the dimensions of the first product, the transport parameters and first transport temperature threshold, a first temperature sustaining bag with a first temperature sustaining agent having a loading temperature that is less than or equal to the first transport temperature threshold; and cause a first instruction to be communicated to cause a worker to load the first product into the first temperature sustaining bag.

Further, some embodiments provide methods of limiting temperature changes of a product during transit, comprising: by a product delivery control circuit: obtaining dimensions of a first product and a first transport temperature threshold below which the first product to be maintained while transported to a delivery location by a delivery vehicle; obtaining transport parameters comprising a predicted transport duration and expected environmental conditions to be encountered during the transport of the first product to the delivery location; selecting, based on the dimensions of the first product, the transport parameters and the first transport temperature threshold, a first temperature sustaining bag from a plurality of different sized temperature sustaining bags, wherein each of the plurality of temperature sustaining bags comprises a temperature sustaining agent encapsulated within an encapsulation cell defined between an interior casing and an exterior casing, and wherein the first temperature sustaining bag comprises a first temperature sustaining agent having a loading temperature that is less than or equal to the first transport temperature threshold; and causing a first instruction to be communicated to cause a worker to load the first product into the first temperature sustaining bag.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system to limit temperature changes of products during transit, comprising:
a plurality of temperature sustaining bags including multiple different sized temperature sustaining bags, wherein each of the plurality of temperature sustaining bags comprises: a product cavity that supports a first product while the first product is transported to a delivery location by a delivery vehicle with the temperature sustaining bag being separate from and removable from the delivery vehicle; an interior casing defining the product cavity; an exterior casing; and an encapsulation cell defined between the interior casing and the exterior casing and a temperature sustaining agent encapsulated within the encapsulation cell;
a product delivery control circuit; and
a memory coupled to the product delivery control circuit and storing computer instructions that when executed by the product delivery control circuit cause the product delivery control circuit to:
obtain dimensions of the first product and a first transport temperature threshold below which the first product to be maintained while transported to the delivery location by the delivery vehicle;
obtain transport parameters comprising a predicted transport duration and expected environmental conditions to be encountered during the transport of the first product to the delivery location;
select, based on the dimensions of the first product, the transport parameters and first transport temperature threshold, a first temperature sustaining bag with a first temperature sustaining agent having a loading temperature that is less than or equal to the first transport temperature threshold; and
cause a first instruction to be communicated to cause a worker to load the first product into the first temperature sustaining bag.

2. The system of claim 1, wherein the first temperature sustaining bag further comprises a fluid distributing material within the encapsulation cell that is configured to distribute the first temperature sustaining agent throughout the encapsulation cell.

3. The system of claim 1, wherein the first temperature sustaining agent in the first temperature sustaining bag is at or below the loading temperature prior to first temperature sustaining bag being selected.

4. The system of claim 3, wherein the first temperature sustaining bag is complete and ready without assembly to receive the first product at the time the first temperature sustaining bag is selected.

5. The system of claim 1, wherein the control circuit in selecting the first temperature sustaining bag is configured to: determine interior dimensions of the product cavity to receive the first product, determine a quantity of the first temperature sustaining agent to be encapsulated and predicted to maintain the temperature of the first product below the first transport temperature threshold, and cause a second instruction to be communicated to cause the manufacturing of the first temperature sustaining bag with the determined interior dimensions and the encapsulated quantity of the first temperature sustaining agent.

6. The system of claim 5, wherein the control circuit in causing the second instruction to be communicated further causes the first temperature sustaining bag to be placed into a temperature environment at least a threshold duration prior to the first product being loaded into the delivery vehicle such that the first temperature sustaining agent is brought to at least the loading temperature prior to being placed into the delivery vehicle.

7. The system of claim 1, wherein the control circuit is configured to determine, based at least on the transport parameters and the first transport temperature threshold, a quantity of the first temperature sustaining agent to be encapsulated, and causes a second instruction to be communicated to cause the determined quantity of the first temperature sustaining agent to be injected into at least the encapsulation cell.

8. The system of claim 1, further comprising:
a temperature control selection system configured to obtain the first transport temperature threshold of the first product, identify a method of transporting the first product by the delivery vehicle to the delivery location, and select from multiple different types of temperature control systems the temperature sustaining bags as a function of the method of transporting.

9. A method of limiting temperature changes of a product during transit, comprising:
by a product delivery control circuit:
obtaining dimensions of a first product and a first transport temperature threshold below which the first product to be maintained while transported to a delivery location by a delivery vehicle;
obtaining transport parameters comprising a predicted transport duration and expected environmental conditions to be encountered during the transport of the first product to the delivery location;
selecting, based on the dimensions of the first product, the transport parameters and the first transport temperature threshold, a first temperature sustaining bag from a plurality of different sized temperature sustaining bags, wherein each of the plurality of temperature sustaining bags comprises a temperature sustaining agent encapsulated within an encapsulation cell defined between an interior casing and an exterior casing, and wherein the first temperature sustaining bag comprises a first temperature sustaining agent having a loading temperature that is less than or equal to the first transport temperature threshold; and
causing a first instruction to be communicated to cause a worker to load the first product into the first temperature sustaining bag.

10. The method of claim 9, wherein the first temperature sustaining bag further comprises a fluid distributing material within the encapsulation cell that is configured to distribute the first temperature sustaining agent throughout the encapsulation cell.

11. The method of claim 9, wherein the selecting the first temperature sustaining bag comprises selecting the first temperature sustaining bag that has the first temperature sustaining agent at or below the loading temperature prior to first temperature sustaining bag being selected.

12. The method of claim 11, wherein the first temperature sustaining bag is complete and ready without assembly to receive the first product at the time the first temperature sustaining bag is selected.

13. The method of claim 9, wherein the selecting the first temperature sustaining bag comprises:
determining interior dimensions of the product cavity to receive the first product;
determining a quantity of the first temperature sustaining agent to be encapsulated and predicted to maintain the temperature of the first product below the first transport temperature threshold; and
causing a second instruction to be communicated to cause the manufacturing of the first temperature sustaining bag with the determined interior dimensions and the encapsulated quantity of the first temperature sustaining agent.

14. The method of claim 13, wherein the causing the second instruction to be communicated further comprises causing the first temperature sustaining bag to be placed into a temperature environment at least a threshold duration prior to the first product being loaded into the delivery vehicle such that the first temperature sustaining agent is brought to at least the loading temperature prior to being placed into the delivery vehicle.

15. The method of claim 9, further comprising:
determining, based at least on the transport parameters and the first transport temperature threshold, a quantity of the first temperature sustaining agent to be encapsulated; and
causing a second instruction to be communicated to cause the determined quantity of the first temperature sustaining agent to be injected into at least the encapsulation cell.

16. The method of claim 9, further comprising:
obtaining the first transport temperature threshold of the first product;
identifying a method of transporting the first product by the delivery vehicle to the delivery location; and
selecting from multiple different types of temperature control systems the temperature sustaining bags to be used in limiting the temperature change of the first product as a function of the method of transporting.
